(19) United States
(12) Patent Application Publication
(10) Pub. No.: US 2009/0198576 A1
(43) Pub. Date: Aug. 6, 2009

(54) SYSTEM AND METHOD FOR BAND PROMOTION

(75) Inventor: Alfred C. Rogers, JR., Raleigh, NC (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Brand New Game, LLC, Raleigh, NC (US)

(21) Appl. No.: 12/043,408

(22) Filed: Mar. 6, 2008

Related U.S. Application Data
(60) Provisional application No. 61/026,269, filed on Feb. 5, 2008.

(51) Int. Cl. G06Q 30/00; A63F 9/24; A63F 9/00

(52) U.S. Cl. 705/14; 273/153 R; 463/9; 463/42

(57) ABSTRACT

Embodiments of the disclosure provide a game including a puzzle game interface pre-populated with alphanumeric characters or symbols, wherein interacting with the pre-populated alphanumeric characters or symbols of the puzzle game interface provides brand promotion.

### CROSS-REFERENCE TO RELATED APPLICATIONS

This patent application claims priority to U.S. Provisional Patent Application No. 61/026,269, entitled “System and Method for Brand Promotion,” filed on Feb. 5, 2008, which is hereby incorporated by reference in its entirety.

### FIELD OF THE DISCLOSURE

Embodiments of the present disclosure relate generally to brand promotion, and more specifically, to a system and method for promoting and advertising a brand by providing a Sudoku-based game.

### BACKGROUND INFORMATION

Brands may drive success in competitive and financial markets, and may indeed become an organization's most valuable asset. Brand promotion may be an effective and convenient way to expand brand recognition in consumers and improve business, trade, and marketability.

Games may be structured or semi-structured activities undertaken for pleasure and enjoyment, and may sometimes be used as an educational tool. Some games may be paper-based, such as crossword puzzles, word search, mazes, etc. Other games may be electronic-based, such as video games, Internet games, etc. Typically characterized by a series of rules, games typically involve elements of skill, strategy, and speed.

A currently popular puzzle game in many countries of the world is “Sudoku.” Originally named Suuji Wa Dokushin Ni Kagiru (“the numbers must be single”) in Japan, the name was later abbreviated as Sudoku (“Su”=number, “Doku”=single). This type of puzzle game has also been called a variety of similar names such as, for example and not by way of limitation, “Number Place” or “Nanpure.” The rules of Sudoku are described in several publications, one example of which is Master Sudoku by Carol Vorderman, copyright 2005 by Three Rivers Press. Referring to FIG. 1A, in standard Sudoku, a player is presented with a nine (9) by nine (9) “grid,” divided into smaller three (3) by three (3) “boxes” consisting of three rows of three cells each. Some cells in the grid are pre-populated with numbers ranging from one (1) to nine (9). To complete the puzzle, the player must fill the remaining empty cells so that each row, column, and “box” contains only one instance of every number from one (1) to nine (9), as shown in FIG. 1B. Printed versions of Sudoku puzzles may be available in puzzle books and/or newspapers. Electronic versions may be played on personal computers, on the Internet, on cell phones, and/or on standalone Sudoku handheld units.

However, a Sudoku-based puzzle game has never been used for brand promotion and/or advertisement. As a result, such a puzzle game may be particularly unique and advantageous for expanding the marketplace for business, increasing sales, and improving customer attention and/or retention.

### SUMMARY OF EMBODIMENTS

Embodiments of the disclosure are directed to a system and method for providing a game for brand promotion.

According to an embodiment of the disclosure, a game may be provided including a puzzle game interface pre-populated with alphanumeric characters or symbols, wherein interacting with the pre-populated alphanumeric characters or symbols of the puzzle game interface provides brand promotion.

In one aspect of the embodiment, the puzzle game may be a Sudoku-based puzzle game, wherein the puzzle game interface comprises a plurality of squares in a matrix of rows and columns such that a first subset of the squares are pre-populated with alphanumeric characters or symbols and a second subset of the squares are empty and configured to be filled with alphanumeric characters or symbols of a brand-related expression. In addition, the brand-related expression may include at least one of a brand, a business entity, a phrase, a slogan, a geographical location, an educational institution, an athletic team, and a non-profit organization. Also, the Sudoku-based puzzle game may include at least one of an 8×8 matrix for a brand-related expression having eight unique alphanumeric characters or symbols, a 9×9 matrix for a brand-related expression having nine unique alphanumeric characters or symbols, a 16×16 matrix for a brand-related expression having sixteen unique alphanumeric characters or symbols, a 25×25 matrix for a brand-related expression having twenty-five unique alphanumeric characters or symbols, and an interlocking matrix having five interlocking 9×9 matrices for a brand-related expression having nine unique alphanumeric characters or symbols.

In another aspect of the embodiment, the game may be provided in at least one of a book, a booklet, a pamphlet, an insert for inserting in a jewel case, a calendar, a flyer, a handbills, packaging, a receipt, a bag, a newspaper, and a premium item. In another embodiment, the game may be provided in an electronic-based format. In yet another embodiment, the game may be based on at least one of the following, hangman, crossword, word twist, scrabble, hangman, and word search.

In yet another aspect of the embodiment, the game may further include a rewards system for receiving completed puzzle games and providing rewards incentives to promote loyalty, retention, and greater brand attraction, wherein the rewards incentives are based on terms and conditions of a brand holder and comprise at least one of rebates, cash, food, gift cards, coupons, sweepstakes entries, and lottery.

According to another embodiment of the disclosure, a system for brand promotion may be provided including a game server for generating puzzle games and receiving completed puzzle games, wherein the game server is connected to at least one game database, a rewards engine for determining eligibility and rewards incentives for complete puzzle games, wherein the rewards engine is connected to at least one rewards database, a web-based graphic user interface (GUI) for providing puzzle games via a network to one or more user devices, and an adapter for communicating with downstream components for performing reward delivery functions.

In one aspect of the embodiment, the network may be the Internet. In another aspect of the embodiment, the one or more user device may be at least one of a desktop computer, a laptop notebook computer, a mobile phone, a personal data assistant (PDA), a smart phone, a mobile phone, a global positioning system (GPS) navigation device, portable multimedia player, and a portable gaming console. In yet another aspect of the embodiment, the downstream components may include at least one of external components and internal components.

According to yet another embodiment of the disclosure, a method for brand promotion may be provided including providing one or more puzzle games to a user device, receiving one or more completed puzzle games from the user device, processing the one or more completed puzzle games to determine whether a user at the user device is eligible for reward options, and providing reward options to the eligible user.

According to yet another embodiment of the disclosure, a method for brand promotion may be provided including receiving one or more puzzle game requests, determining a brand-related expression to be used, generating one or more puzzle games based on the one or more requests using the determined brand-related expression, and distributing the one or more puzzle games for brand promotion.

In one aspect of the embodiment, the one or more puzzle game requests may be received from one or more customers for customized puzzle games. In another aspect of the embodiment, the brand-related expression may be determined based on at least a brand, slogan, phrase, and customer-related expression. In yet another aspect of the embodiment, the brand-related expression may be determined by manually by an administrator, automatically by a computer server, or a combination thereof.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIGS. 1A-1B depict a conventional Sudoku puzzle and solution.

FIGS. 2A-2B depict an exemplary puzzle and solution, according to an embodiment of the present disclosure.

FIGS. 3A-3B depict an exemplary puzzle and solution, according to another embodiment of the present disclosure.

FIGS. 4A-4B depict an exemplary puzzle and solution, according to another embodiment of the present disclosure

FIGS. 5A-5B depict an exemplary puzzle and solution, according to another embodiment of the present disclosure

FIGS. 6A-6B depict an exemplary puzzle and solution, according to another embodiment of the present disclosure

FIG. 7 depicts an exemplary illustration of a system architecture for an electronic-based puzzle, according to an embodiment of the disclosure.

FIG. 8 depicts an exemplary screenshot for ordering and customizing a brand-related expression for a puzzle game, according to an embodiment of the disclosure, according to an embodiment of the disclosure.

FIG. 9 depicts an exemplary flowchart for brand promotion using a puzzle, according to an embodiment of the disclosure.

FIG. 10 depicts an exemplary flowchart for brand promotion using a puzzle, according to an embodiment of the disclosure.

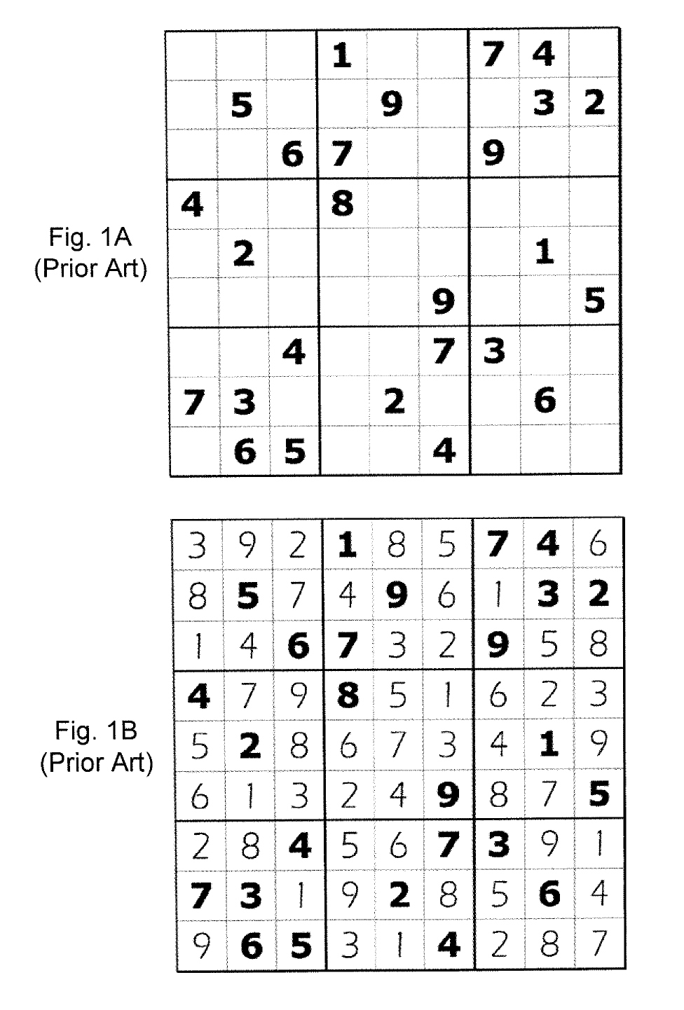

### DETAILED DESCRIPTION OF EMBODIMENTS

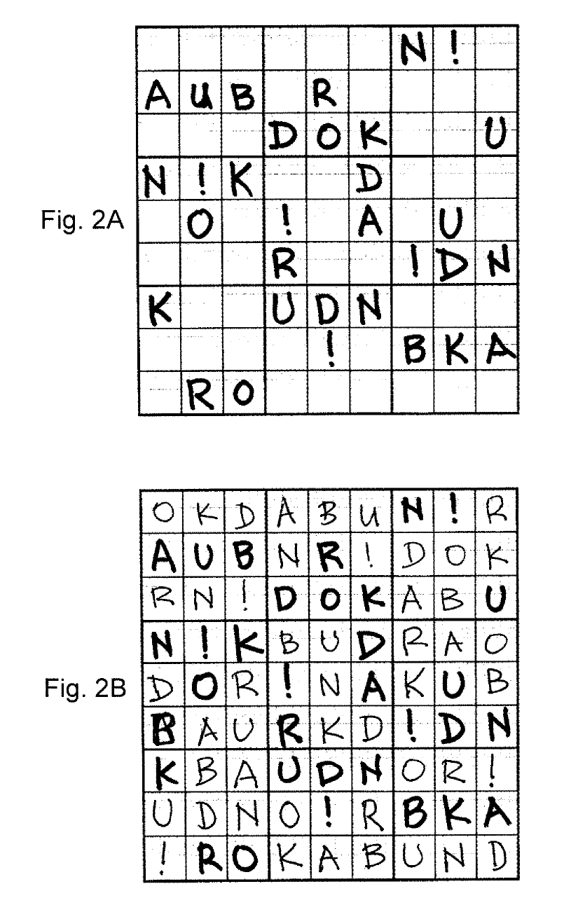

FIG. 2A depicts an exemplary puzzle game according to an embodiment of the present disclosure. In this example, a player is presented with a nine (9) by nine (9) “grid” or matrix of squares, divided into smaller three (3) by three (3) “boxes” consisting of three rows of three cells each. Some cells in the grid may be pre-populated with nine (9) alphanumeric characters and/or symbols. In one embodiment, these nine (9) alphanumeric characters and/or symbols may be unique and may be the alphanumeric characters and/or symbols of a particular brand. For example, referring to FIG. 2A, the nine (9) unique alphanumeric characters may taken from a brand, such as “B-r-a-n-d-o-k-u-!” Other brands, slogans, phrases, or similar depictions may also be provided. To complete the puzzle game, the player must fill the remaining empty cells so that each row, column and “box” contains only one instance of predetermined alphanumeric characters and/or symbols, e.g., “B,” “R,” “A,” “N,” “D,” “O,” “K,” “U,” or “!,” as depicted in FIG. 2B.

By playing a puzzle game using these various alphanumeric characters and/or symbols, a player not only experiences the enjoyment and pleasure of the game itself, but is also exposed to a promoted brand, such as “Brandoku!,” “Starbucks,” “McDonalds,” etc. In addition to brands, other various expressions may also be promoted For example, these may include slogans, phrases, geographical locations, schools, teams, non-profit organizations, and/or other related expressions. For instance, a puzzle game may use letters from these various expressions: “MyFlorida,” “Baltimore,” “My Florist,” “UNCRules!,” “Wolfpack!,” “BlueJays!,”“Falcons#1,” “Bojangles,” or “PraiseGod.” It should be appreciated that these expressions are exemplary and other various expressions and/or embodiments may also be provided.

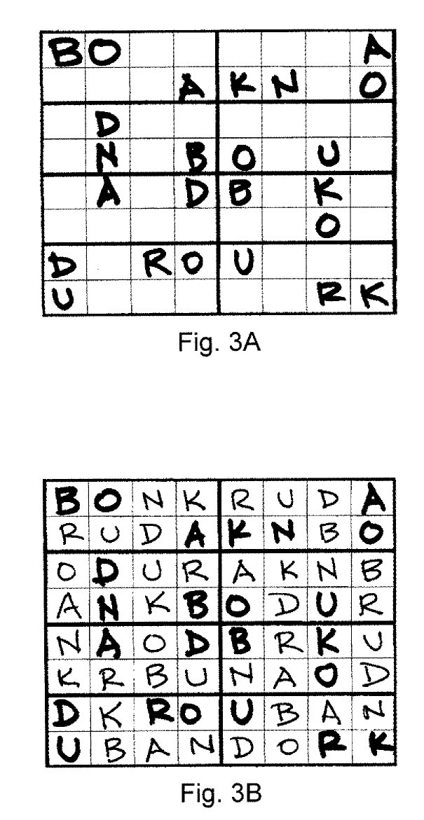

It should be appreciated that while embodiments of the present disclosure are described in a three (3) by three (3) puzzle game format, puzzle games in other various sizes and formats may also be provided. For example, in one embodiment, a puzzle game and solution may have a two (2) by four (4) box configuration, as depicted in FIGS. 3A-3B. In this example, rather than having nine (9) alphanumeric characters and/or symbols as shown in FIGS. 2A-2B, the puzzle game and solution of FIGS. 3A-3B may have eight (8) unique alphanumeric characters and/or symbols, such as “B-R-A-N-D-O-K-U.” Other various brands and/or related expressions may also be provided.

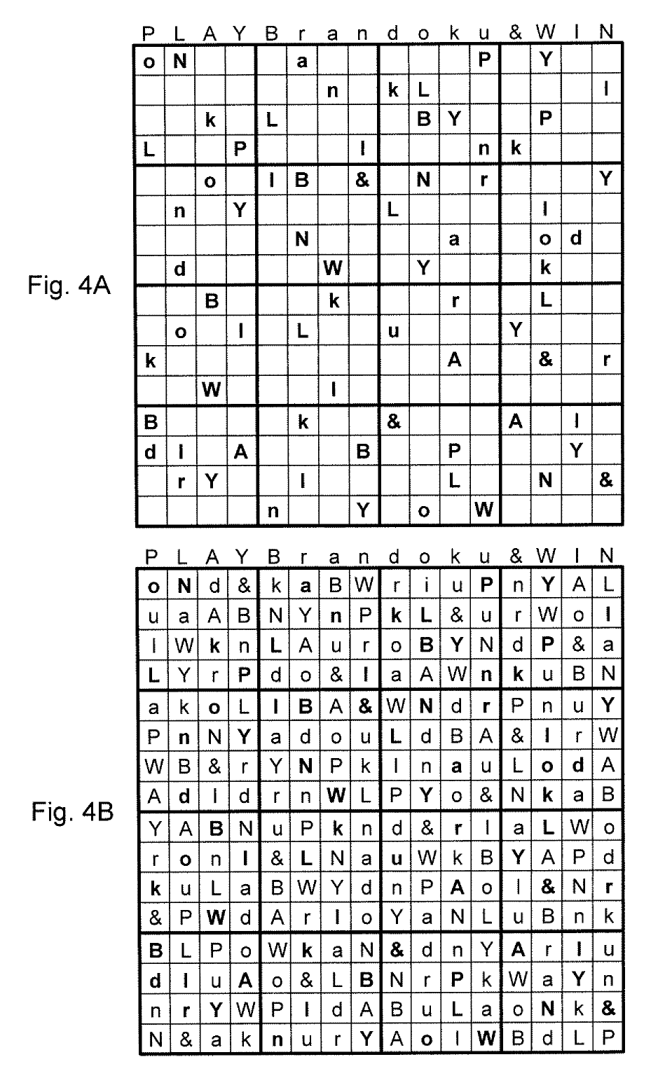

In another embodiment, a puzzle game and solution may have a four (4) by four (4) box configuration, as depicted in FIGS. 4A-4B. In this example, instead of having nine (9) unique alphanumeric characters and/or symbols as shown in FIGS. 2A-2B, FIGS. 4A-4B may have sixteen (16) unique alphanumeric characters and/or symbols. For example, the phrase “P-l-a-y-B-r-a-n-d-o-k-u-&-W-I-N” which includes sixteen (16) unique alphanumeric characters and/or symbols may be used. Other various brands and/or related expressions may also be provided.

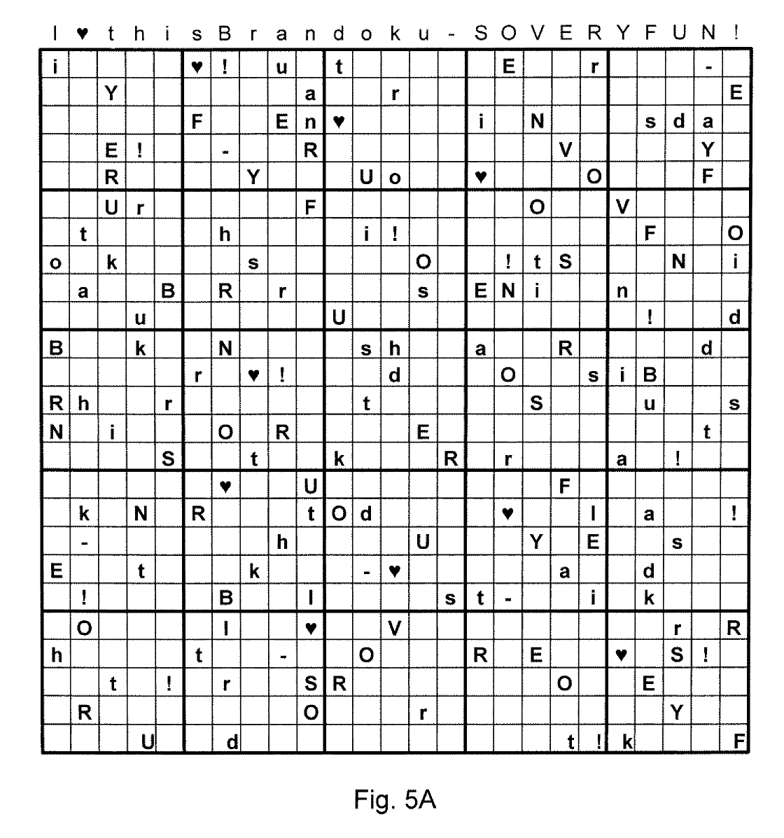

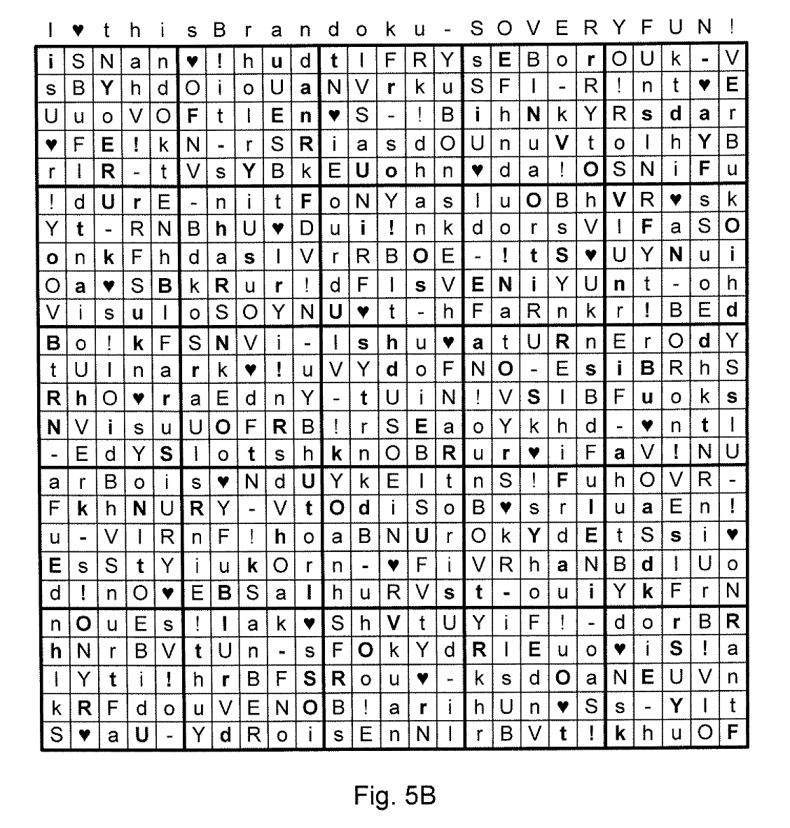

In another embodiment, a puzzle game and solution may have a five (5) by five (5) box configuration, as depicted in FIGS. 5A-5B. In this example, instead of having nine (9) unique alphanumeric characters and/or symbols as shown in FIGS. 2A-2B, FIGS. 5A-5B may have twenty-five (25) unique alphanumeric characters and/or symbols. For example, the phrase “I-♡-t-h-i-s-B-r-a-n-d-o-k-u-S-O-V-E-R-Y-F-U-N-!” which includes twenty-five (25) unique alphanumeric characters and/or symbols may be used. Other various brands and/or related expressions may also be provided.

By having various box configurations (e.g., an N×N box) having a variety of unique alphanumeric characters and/or symbols (e.g., N² characters and/or symbols for an N×N box), brand promotion may not be limited to merely nine (9) characters and/or symbols.

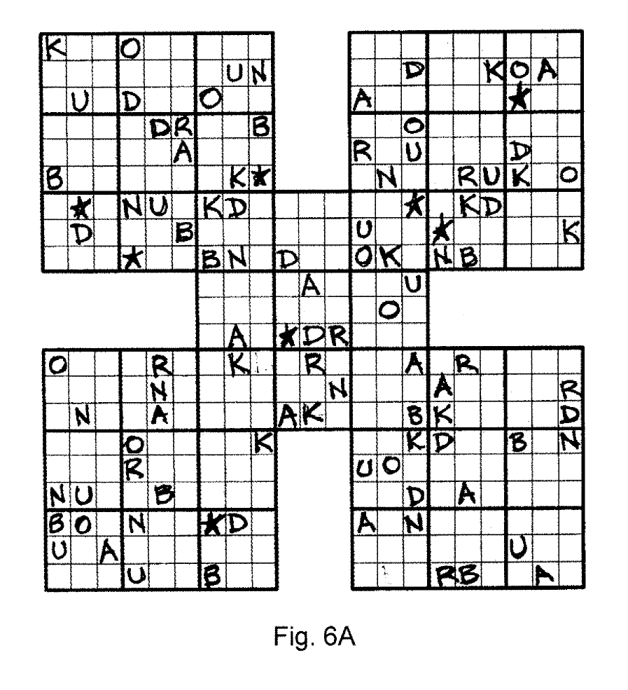

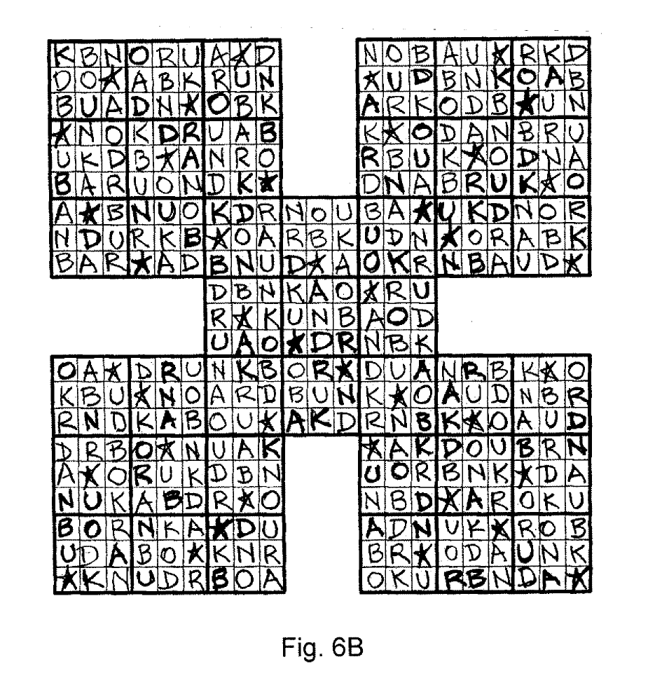

Furthermore, it should be appreciated that other various advanced box configurations may also be provided. For example, in one embodiment, FIGS. 6A-6B depict a puzzle and solution with a unique interlocking arrangement. Such a configuration may provide a greater challenge for the player and increased brand promotion in a single puzzle. Although FIGS. 6A-6B depict five (5) interlocking 3×3 puzzle, it should be appreciated that other various arrangements and/or configurations may also be provided. For example, the number of interlocking boxes (e.g., at least two interlocking puzzles) and the size/dimension of the boxes may also vary (e.g., 2×4, 4×4, 5×5, etc.).

According to an embodiment of the present disclosure, a puzzle game may be provided in various paper-based formats. For example, in one embodiment, a puzzle game may be provided as a booklet. These may include, but not limited to, books, CD (compact disc) or jewel case inserts, pamphlets, paper-based premium items, etc. For example, a booklet in the size, shape, and dimension of a CD jewel case may be provided. In another embodiment, the puzzle game may be provided as a calendar. These may include, but not limited to, a puzzle-a-day calendar, give-away calendars, weekly/yearly calendars, etc. Other various paper-based formats may also be provided, such as flyers, handbills, packaging, receipts, bags, newspapers, etc. It should be appreciated that such paper-based puzzle game embodiments may be customized to optimize various marketing and business approaches.

In addition to promoting a brand, embodiments of the present disclosure may also include various reward incentives. For example, in one embodiment, one or more completed puzzle games from a booklet may be submitted to redeem one or more rewards. These rewards may be provided by one or more merchants attempting to promote their brand. For instance, by way of example, Starbucks Coffee chains may distribute puzzle game booklets using the letters “S-t-a-r-b-u-c-k-s.” Additionally, each booklet may includes rules on how to enter and win various rewards. For example, completed puzzle entries may be submitted under the rules specified in the booklet to the merchant to have a chance to win prizes, e.g., $5,000 or other rewards or incentives. As a result, not only does a puzzle game provide enjoyment to customers while building brand recognition, embodiments of the present disclosure may also provide other incentives (e.g., rewards, prizes, etc.) to promote customer loyalty, retention, and greater brand attraction. It should be appreciated that puzzle games described are merely exemplary and does not in any way limit embodiments of the present disclosure. For example, a variety of puzzle games may be used and various difficulties may be provided. Other various embodiments may also be provided.

The various incentives, rewards, and/or prizes may vary accordingly from merchant to merchant, In one embodiment, for example, each completed puzzle game or group of completed puzzle games may be redeemed for an instant reward/prize, such as a cup of coffee or food, cash, gift card, etc. In another embodiment, each completed puzzle game or group of completed puzzle games may be considered as an entry to win one or more prizes. Such an entry may be similar to that of a raffle ticket or an entry for a sweepstakes. Again, these illustrations are provided merely for exemplary purposes since the terms and conditions for receiving prizes and/or rewards may vary with each puzzle game and/or merchant. Other various incentives may be coupled with the puzzle games.

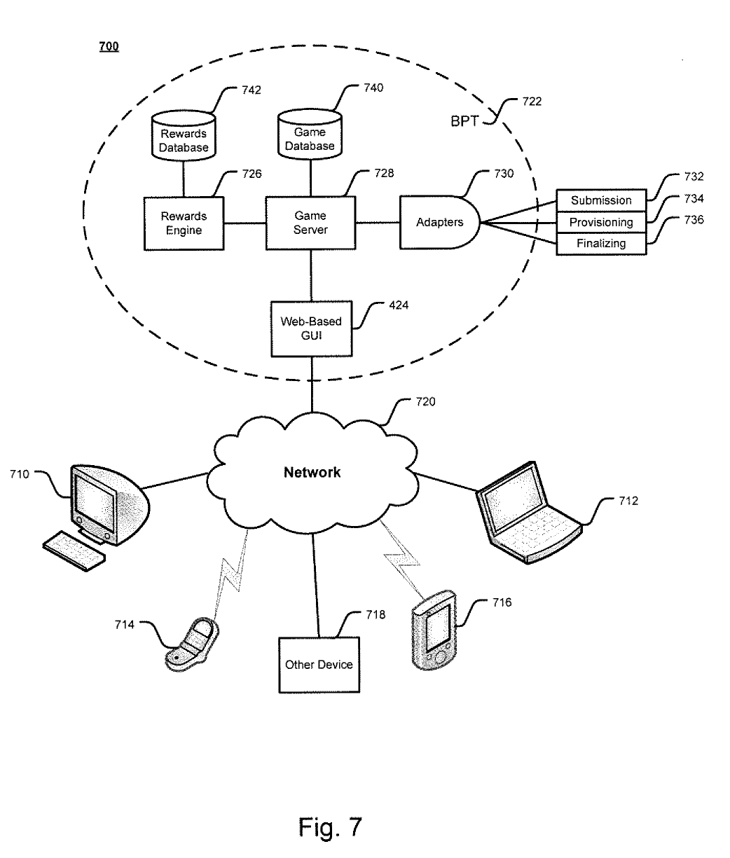

It should be appreciated that electronic-based puzzle games may also be provided. For example, FIG. 7 depicts an exemplary system of an electronic puzzle game, according to an embodiment of the disclosure. System 700 may comprise a user interface device from which a user or customer connects to a Brand Promotion Tool (BPT) 722 via a network 720.

A user interface device may include a computer 710, a laptop/notebook 712, a mobile phones a personal data assistant (PDA) 716, or other similar device 718. The user interface device may connect to the network 720 in a variety of ways, such as via wired or wireless broadband connection. In one embodiment, wired broadband connection may include long-range optical data communications, local area network based protocols, wide area networks, and/or other similar applications. In another embodiment, wireless broadband connection may include long-range wireless radio, local area wireless network such as 802.11 based protocols, wireless wide area network such as WiMax, and/or other similar applications. Other various embodiments may also be provided. In one embodiment, network 720 may comprise the Internet. Other networks may also be utilized for connecting each of the various systems and/or servers.

Brand Promotion Tool (BPT) 722 may include a network-based user interface, such as a Web-Based Graphic User Interface (GUI) 724, from which a user interface device may connect via a network 720. Other various user interfaces may also be used. For example, one such user interface may provided by a merchant's local area network (LAN). Brand Promotion Tool (BPT) 722 may also include a Game Server 728 that may connect the web-based GUI 724 with Rewards Engine 726 and Adapters 730. Game Server 728 may also connect to a Game Database 740, and Rewards Engine 726 may connect to a Rewards Database 742. Other variations and components may also be provided.

Game Server 728 may receive and process signals from the web-based GUI 724 and/or user interface device via a network 720 as described above. These signals may include one or more requests for puzzle games. In one embodiment, Game Server 728 may process the signals and retrieve the one or more requested puzzle games from Game Database 740. In another embodiment, Game Server 728 may also communicate with the user interface device to request instructions regarding one or more received signals. In yet another embodiment, Game Server 728 may also host the one or more requested puzzle games or transmit the one or more puzzle games to played locally at the user interface device. Other various embodiments may also be provided.

Rewards Engine 726 may be connected to the Game Server 728 and may retrieve rewards/incentives from Rewards Database 742 and link with one or more puzzles/games to be played by a user or customer. Rewards Engine 726 may provide customized incentives (e.g., rewards, prizes, etc.) to fit a merchant's business needs. In another embodiment, Rewards Engine 726 may also store information regarding a particular user to keep track of the number of rewards received by a particular user. Other various data and/or information may also be stored. For example, a particular prize may limit a prize to one winner per household. In this example, Rewards Engine 726 may store information related to a user IP address, which may be indicative of a particular household. Accordingly, in the event a second prize is sought from the same IP address, Rewards Engine 726 may bar the prize redemption and any subsequent prize redemptions from that particular IP address. Other various embodiments may also be provided.

Adapters 730 may be provided to the Brand Promotion Tool (BPT) 722 for communication with various downstream systems, e.g., outside of the Brand Promotion Tool (BPT) 722, for performing reward delivery functions such as submission 732, provisioning 734, finalizing 736, and other related functions. In one embodiment, adapters 730 may recognize system interfaces, communication protocols, message formats, and/or data elements in the messages/signals. These downstream systems may be merchant-side or vendor-side components for delivering rewards upon redemption by one or more customers. Other variations may also be provided.

It should be appreciated that various electronic-based embodiments may also be provided. These may include, but not limited to, games played via websites, handheld game devices, game consoles, local game servers, remote game servers, etc.

While shown as separate servers and/or databases, it should be appreciated that the contents of the servers and/or databases, as described above, may be combined into fewer or greater numbers of servers, modules, and/or databases. Other data and/or information may also be stored and/or obtained from these servers, modules, and/or databases.

While one configuration is shown in FIG. 7, it should be appreciated by one of ordinary skill in the art that other configurations of these various servers, modules, databases, and/or components may also be provided. For example, for ubiquitous accessibility, Brand Promotion Tool (BPT) 722 may be implemented as a web-based tool by utilizing a 3-tier architecture. The first tier may represent a user interface tier that includes, for example, the web-based GUI 724. The second tier may include the business logic tier that includes, for example, the rewards engine 726, the game server 728, and adapters 730 for communication with downstream systems. The third tier may represent a database tier that includes, for example, a rewards database 742 and a game database 740, or other similar database. Other various configurations and designs may also be provided.

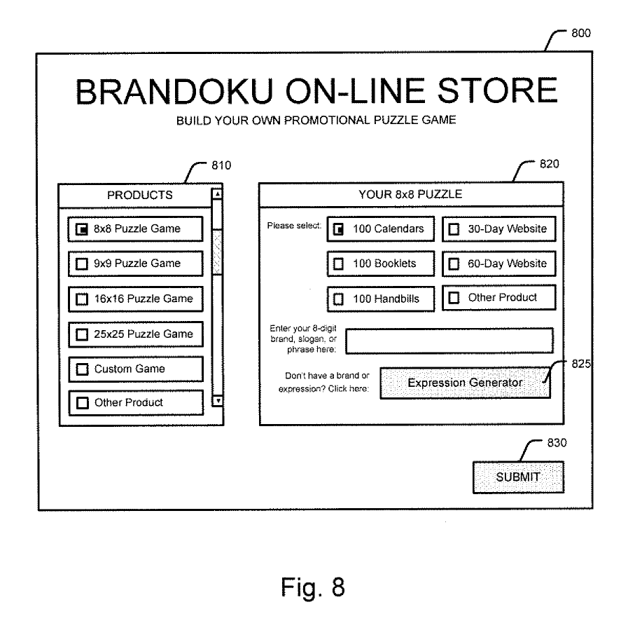

According to an embodiment of the present disclosure, registration and/or generation of one or more puzzle games utilizing one or more brands, phrases, slogans, or other related expression may be provided. For example, FIG. 8 depicts an exemplary screenshot for ordering and customizing a brand-related expression for a puzzle game, according to an embodiment of the disclosure, according to an embodiment of the disclosure. In this example, a merchant may access a website 800 to order a puzzle game for a particular brand, e.g., Starbucks. The merchant may select an 8×8 puzzle game under a list of various products 810. The merchant may then enter a brand with the same number of digits corresponding to the size of the puzzle in one or more form fields in a customizing window 820. In this embodiment, the merchant may also place one or more orders for puzzle games (e.g., 100 calendars, 30-day website) using the particular brand from the customizing window 820. In the event the merchant does not have a brand-related expression to enter into the form field, the merchant may click an Expression Generator link 825 in the customizing window 820 to generate an expression, It should be appreciated that additional windows may be provided to the merchant asking for additional information about its business, clients, etc., to best to generate one or more appropriate expression to include in a puzzle game. In another embodiment, the expression generatoe may also be connected to one or databases, external and/or internal, to retrieve information to assist in the generation of an appropriate expression for the puzzle game. Once an expression is created for the puzzle game, the merchant may finalize the order by submitting the order 830. It should be appreciated that the expression generator may be integrated with the puzzle generator and may have the processing logic to generate the requested number of puzzle games by the merchant as well as the brand-related expression for the puzzle games.

It should also be appreciated that the website and/or generator may also be customized to perform a variety of other functions. For example, a merchant may have a particular brand, but the characters of the particular brand may not be unique. For instance, Coca-Cola may desire to provide puzzle games to enhance brand recognition, but “Coca-Cola” has repeated instances of “C,” “o,” and “a.” As a result, the Coca-Cola merchant may access a website to register a brand and an expression generator may provide one or more possible expressions to be used for this particular merchant. In one embodiment, when the merchant enters “Coca-Cola” as it's merchant brand, the expression generator may retrieve, from one or more databases, slogans, phrases, themes, etc., to be used for generating one or more puzzles. In this example, the expression generator may be retrieve the phrase “RealThing,” which has nine (9) unique alphanumeric characters and/or symbols, and present it to the merchant. Other various expressions may be retrieved and or generated as well. Once the merchant views the various expression it may use in one or more puzzle games, the merchant may select the expression and continue with the registration and/or purchase. In another embodiment, the merchant may enter into one or more form fields other themes, expressions, ideas, etc. In this example, the expression generator may store this information in one or more databases. Processing logic in the expression generator may retrieve this information and generate one or more expressions for the merchant to select from. Other various embodiments may also be provided.

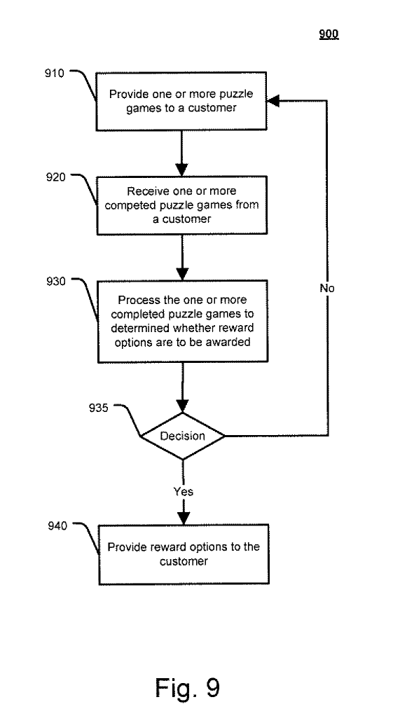

According to an embodiment of the present disclosure, a method for brand promotion may be provided. FIG. 9 depicts an exemplary flowchart for brand promotion, according to an exemplary embodiment. The exemplary method 900 is provided by way of example, as there are a variety of ways to carry out methods disclosed herein. The method 900 shown in FIG. 9 may be executed or otherwise performed by one or a combination of various systems. The method 900 is described below as carried out by the system 700 shown in FIG. 7 by way of example, and various elements of the system 700 are referenced in explaining the example method of FIG. 9. Each block shown in FIG. 9 represents one or more processes, methods, or subroutines carried in the exemplary method 900. A computer readable media comprising code to perform the acts of the method 900 may also be provided.

Referring to FIG. 9, as depicted in block 910, one or more puzzle games may be provided to a customer. The one or more puzzle games may be provided in one or more various formats, such as paper-based, electronic, or other format. At block 920, one or more completed puzzle games may be received from the customer. At block 930, the one or more completed puzzle games may be processed to determine whether the customer is eligible for reward options. For example, if the terms and conditions of the puzzle games stipulate that the completed puzzle games must be completed accurately, then only those completed puzzle games completed accurate may be eligible to receive reward options. Other various determinations and/or embodiments may also be provided. At block 935, a decision may be made by the Brand Promotion Tool (BPT) 722 to determine where reward options will be provided to the customer. If the decision is “no,” the method 900 may be repeated, starting at block 910. If the decision is “yes,” the reward options may be presented and/or provided to the customer, as depicted in block 940. Other various embodiments may also be provided.

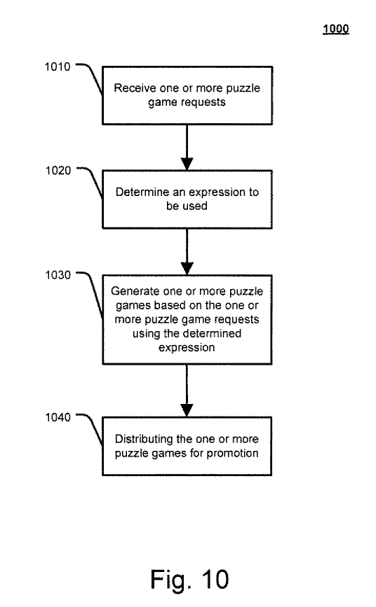

According to an embodiment of the present disclosure, a method for brand promotion may be provided. FIG. 10 depicts an exemplary flowchart for brand promotion, according to an exemplary embodiment. The exemplary method 1000 is provided by way of example, as there are a variety of ways to carry out methods disclosed herein. The method 1000 shown in FIG. 10 may be executed or otherwise performed by one or a combination of various systems. The method 1000 is described below as carried out by the system 700 shown in FIG. 7 by way of example, and various elements of the system 700 are referenced in explaining the example method of FIG. 10. Each block shown in FIG. 10 represents one or more processes, methods, or subroutines carried in the exemplary method 1000. A computer readable media comprising code to perform the acts of the method 1000 may also be provided.

Referring to FIG. 10, as depicted in block 1010, one or more puzzle game requests may be received. For example, a customer or merchant may request one or more puzzle games. At block 1010, an expression to be used in the requested puzzle game may be determined. For example, the expression may be a brand, slogan, phrase, or other related expression. Additionally, the expression may be determined by the customer or merchant, a processor at the Brand Promotion Tool (BPT) 722 (e.g., an expression processing logic), an administrator, one or more databases, or a combination thereof. Other various ways to determine an expression may also be provided.

At block 1030, the one or more puzzle games may be generated based on the one or more puzzle game requests using the determined expression. In this example, a puzzle generator at the Brand Promotion Tool (BPT) 722, which may be connected to the Game Server 728 and the Rewards Engine 726, may generate the one or more puzzles based on the customer's or merchant's request using the expression determined at block 1020.

At block 1040, the one or more puzzle games may be distributed. For example, the one or more puzzle games, which may be paper-based and/or electronic, may be distributed for brand promotion and advertisement. Other various embodiments may also be provided.

It should be appreciated that while embodiments of the present disclosure are directed to alphanumeric characters and/or symbols that spell particular brands or words (e.g., “S-t-a-r-b-u-c-k-s,” “M-c-D-o-n-a-l-d-s,” etc.), other various non-brand embodiments may also be provided. For example, slogans, phrases, pictorials, symbols, and other variations and/or expressions may be provided. These may include “I-♡-W-e-n-d-y-'-s” for Wendy's fast food chain, Coca-Cola's “R-e-a-l-t-h-i-n-g” slogan, etc.

While embodiments of the present disclosure are directed towards Sudoku-based puzzle games, it should be appreciated that other various games may also be provided. These may include, but not limited to, crossword puzzles, word twist, scrabble, hangman, word search, etc.

It should also be appreciated that embodiments of the present disclosure may provide single puzzle games, a series of puzzle games, or other various combinations. Furthermore, it should be appreciated that rewards and/or incentives may also be provided based on tournament, head-to-head challenge, speed or time-based, and/or other various rules, factors, terms, and conditions.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A game, comprising:
a puzzle game interface pre-populated with alphanumeric characters or symbols, wherein interacting with the pre-populated alphanumeric characters or symbols of the puzzle game interface provides brand promotion.

2. The game of claim 1, wherein the puzzle game is a Sudoku-based puzzle game, wherein the puzzle game interface comprises a plurality of squares in a matrix of rows and columns such that a first subset of the squares are pre-populated with alphanumeric characters or symbols and a second subset of the squares are empty and configured to be filled with alphanumeric characters or symbols of a brand-related expression.

3. The game of claim 2, wherein the brand-related expression comprises at least one of a brand, a business entity, a phrase, a slogan, a geographical location, an educational institution, an athletic team, and a non-profit organization.

4. The game of claim 2, wherein the Sudoku-based puzzle game comprises at least one of an 8×8 matrix for a brand-related expression having eight unique alphanumeric characters or symbols, a 9×9 matrix for a brand-related expression having nine unique alphanumeric characters or symbols, a 16×16 matrix for a brand-related expression having sixteen unique alphanumeric characters or symbols, a 25×25 matrix for a brand-related expression having twenty-five unique alphanumeric characters or symbols, and an interlocking matrix having five interlocking 9×9 matrices for a brand-related expression having nine unique alphanumeric characters or symbols.

5. The game of claim 1, wherein the game is provided in at least one of a book, a booklet, a pamphlet, an insert for inserting in a jewel case, a calendar, a flyer, a handbills, packaging, a receipt, a bag, a newspaper, and a premium item.

6. The game of claim 1, wherein the game is provided in an electronic-based format.

7. The game of claim 1, wherein the game is based on at least one of the following:
hangman, crossword, word twist, scrabble, hangman, and word search.

8. The game of claim 1, further comprises a rewards system for receiving completed puzzle games and providing rewards incentives to promote loyalty, retention, and greater brand attraction.

9. The game of claim 8, wherein the rewards incentives are based on terms and conditions of a brand holder and comprise at least one of rebates, cash, food, gift cards, coupons, sweepstakes entries, and lottery.

10. A system for brand promotion, comprising:
a game server for generating puzzle games and receiving completed puzzle games, wherein the game server is connected to at least one game database;
a rewards engine for determining eligibility and rewards incentives for complete puzzle games, wherein the rewards engine is connected to at least one rewards database;
a web-based graphic user interface (GUI) for providing puzzle games via a network to one or more user devices; and
an adapter for communicating with downstream components for performing reward delivery functions.

11. The system of claim 10, wherein the network is the Internet.

12. The system of claim 10, wherein the one or more user device is at least one of a desktop computer, a laptop notebook computer, a mobile phone, a personal data assistant (PDA), a smart phone, a mobile phone, a global positioning system (GPS) navigation device, portable multimedia player, and a portable gaming console.

13. The system of claim to, wherein the downstream components comprise at least one of external components and internal components.

14. A method for brand promotion, comprising:
providing one or more puzzle games to a user device;
receiving one or more completed puzzle games from the user device;
processing the one or more completed puzzle games to determine whether a user at the user device is eligible for reward options; and
providing reward options to the eligible user.

15. The method of claim 14, wherein the one or more puzzle games are Sudoku-based puzzle games for brand promotion, wherein the puzzle games comprise a plurality of squares in a matrix of rows and columns such that a first subset of the squares are pre-populated with alphanumeric characters or symbols and a second subset of the squares are empty and configured to be filled with alphanumeric characters or symbols of a brand-related expression.

16. A computer readable media comprising code to perform the acts of the method of claim 14.

17. A method for providing puzzle game, comprising:
receiving one or more puzzle game requests;
determining a brand-related expression to be used;
generating one or more puzzle games based on the one or more requests using the determined brand-related expression; and
distributing the one or more puzzle games for brand promotion.

18. The method of claim 17, wherein the one or more puzzle game requests are received from one or more customers for customized puzzle games.

19. The method of claim 17, wherein the brand-related expression is determined based on at least a brand, slogan, phrase, and customer-related expression.

20. The method of claim 17, wherein the brand-related expression is determined by manually by an administrator, automatically by a computer server, or a combination thereof.

21. A computer readable media comprising code to perform the acts of the method of claim 17.
